(19) United States
(12) Patent Application Publication
(10) Pub. No.: US 2015/0046002 A1
(43) Pub. Date: Feb. 12, 2015

(54) SELF-BALANCE MOBILE CARRIER

(71) Applicant: Generalplus Technology Inc., Hsinchu City (TW)

(72) Inventors: Bing Huang SHIH, Hsinchu City (TW); Tung-Tsai LIAO, Hsinchu City (TW); Yu Cheng LIAO, Jhubei City (TW)

(73) Assignee: Generalplus Technology Inc., Hsinchu City (TW)

(21) Appl. No.: 14/169,973

(22) Filed: Jan. 31, 2014

(30) Foreign Application Priority Data
Aug. 6, 2013 (TW) 102214684

(51) Int. Cl. B62K 3/00; B62K 1/00; B62M 7/12

(52) U.S. Cl. CPC B62K 3/007; B62M 7/12; B62K 1/00
USPC 701/22

(57) ABSTRACT

A self-balance mobile carrier is provided in the present invention. The self-balance mobile carrier includes a first direction load cell, a second direction load cell, a third direction load cell, a fourth direction load cell, a motion apparatus and a control circuit. Each of the load cells respective include a pressure-sensing plane and an electrical signal output terminal, for respectively converting the pressure on the pressure-sensing plane to an electrical signal and outputting the electrical signal to the electrical signal output terminal. The control circuit is coupled to the electrical signal output terminals of the first, second, third, and fourth direction load cells and the motion apparatus. The control circuit changes the moving direction of the motion apparatus according to the difference of the electrical signals of the first, second, third, and fourth direction load cells.

This application claims priority of No. 102214684 filed in Taiwan R.O.C. on Aug. 6, 2013 under 35 USC 119, the entire content of which is hereby incorporated by reference.

### BACKGROUND OF THE INVENTION

1. Field of the Invention

The invention relates to a moving carrier, and more particularly to a self-balance mobile carrier.

2. Related Art

With the progress of the technology, the electronic technology has been progressed from the earliest vacuum tube and transistor to the integrated circuit chip, which has the quite wide applications. Thus, the electronic products have gradually become the indispensable essentials in the life of the modern human beings. In 2001, .Dean Kamen and DEKA

Company promote Segway Scooter which is a scooter with coaxial two wheels. As shown in FIG. 1, FIG. 1 illustrates a scooter with coaxial two wheels in the conventional art. Referring to FIG. 1, the speed of the scooter can reach 20 km/hr. It uses three gyroscopes to balance its car body. In addition, there are two spare gyroscopes in the scooter. The connection between the handrail and chassis can support the driver's balance with the inclined body during cornering action.

The conventional art uses gyroscope, g-sensor or accelerometer to senses the balance of the motion apparatus. However, the means for controlling the motion apparatus causes the complexity of the system and higher cost.

### SUMMARY OF THE INVENTION

In view of the above-identified problems, it is therefore an object of the invention to provide a self-balance mobile carrier. The self-balance mobile carrier uses the foot pressure distribution to determine the user's balance direction, to further control the corresponding motion of the motion apparatus. Thus, the self-balance mobile carrier can avoid the complexity of the design is reduced, and the cost can be reduced, accordingly.

To achieve the above-identified object, the invention provides a self-balance mobile carrier, the self-balance mobile carrier includes a first direction load cell, a second direction load cell, a third direction load cell, a motion apparatus and a control circuit. The first direction load cell, the second direction load cell and the third direction load cell respectively include a pressure-sensing plane and an electrical signal output terminal. The first direction load cell is used for converting a pressure of the pressure-sensing plane thereof into a first electrical signal and outputs the first electrical signal to the electrical signal output terminal thereof. The second direction load cell is used for converting a pressure of the pressure-sensing plane thereof into a second electrical signal and outputs the second electrical signal to the electrical signal output terminal thereof. The third direction load cell is used for converting a pressure of the pressure-sensing plane thereof into a third electrical signal and outputs the third electrical signal to the electrical signal output terminal thereof. The motion apparatus includes a motion mechanism and a carrier plane. The carrier plane thereof is used for carrying the first direction load cell, the second direction load cell, and the third direction load cell.

The control circuit is coupled to the electrical signal output terminals of the first direction load cell, the second direction load cell, and the third direction load cell and the motion apparatus. The control circuit changes the moving direction of the motion apparatus according to the difference of the first electrical signal, the second electrical signal and the third electrical signal.

According to a preferred embodiment of the present invention, the self-balance mobile carrier further includes a fourth direction load cell. The fourth direction load cell includes a pressure-sensing plane and an electrical signal output terminal. The fourth direction load cell is used for converting a pressure of the pressure-sensing plane thereof into a fourth electrical signal and outputs the fourth electrical signal to the electrical signal output terminal thereof. The control circuit is further coupled to the electrical signal output terminal of the fourth direction load cell. The carrier plane is used for carrying the fourth direction load cell. The control circuit changes the moving direction of the motion apparatus according to the difference of the first electrical signal, the second electrical signal, the third electrical signal and the fourth electrical signal.

The spirit of the present invention is to use people's balancing capabilities and multiple load cells to detect foot pressure distribution to determine the user's balance direction, and then the load cells further control the corresponding motion of the motion apparatus. Thus, the complexity of the system is reduced. In addition, the mobile carrier can operate without the gyroscope, g-sensor or accelerometer.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 illustrates a scooter with coaxial two wheels in the conventional art.

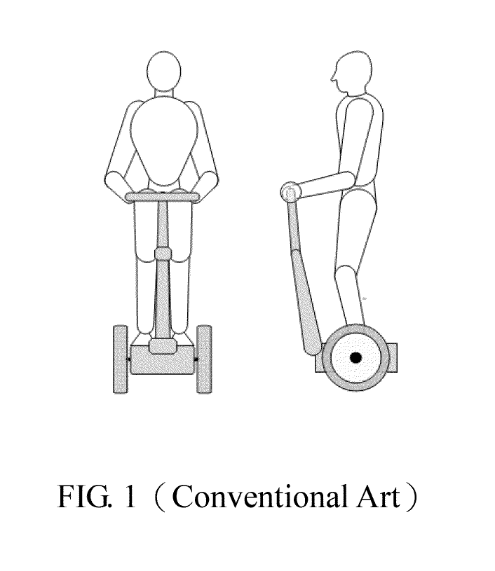

FIG. 2 illustrates a diagram depicting a self-balance mobile carrier according to a preferred embodiment of the present invention.

FIG. 3 illustrates a diagram depicting a self-balance mobile carrier according to a preferred embodiment of the present invention.

### DETAILED DESCRIPTION OF THE INVENTION

The present invention will be apparent from the following detailed description, which proceeds with reference to the accompanying drawings, wherein the same references relate to the same elements.

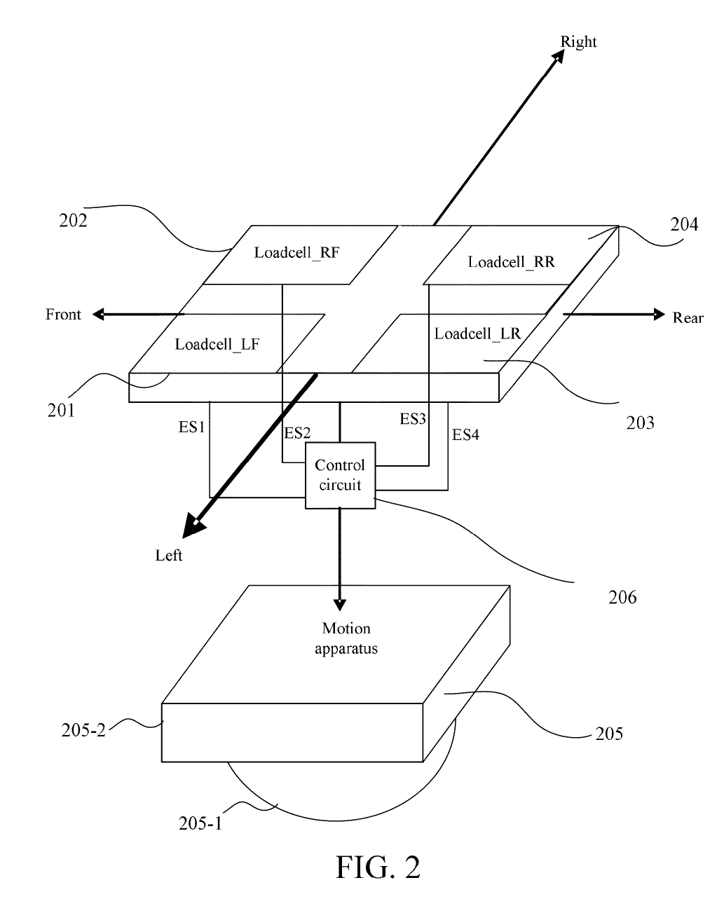

FIG. 2 illustrates a diagram depicting a self-balance mobile carrier according to a preferred embodiment of the present invention. Referring to FIG. 2, the self-balance mobile carrier includes a first direction load cell 201, a second direction load cell 202, a third direction load cell 203, a fourth direction load cell 204, a motion apparatus 205 and a control circuit 206. Each of the load cells 201, 202, 203 and 204 respectively include a pressure-sensing plane and an electrical signal output terminal. The function of the load cells 201, 202, 203 and 204 are to respectively convert the pressures on the pressure-sensing planes into electrical signals and to output the electrical signals to the electrical signal output terminals thereof. The control circuit 206 is coupled to the electrical signal output terminals of the first direction load cell 201, the second direction load cell 202, the third direction load cell 203 and the fourth direction load cell 204 and the motion apparatus 205. The motion apparatus 205 includes a motion mechanism 205-1 and a carrier plane 205-2. The carrier plane 205-2 is used for carrying the first direction load cell 201, the second direction load cell 202, the third direction load cell 203, the fourth direction load cell 204 and a user.

In the present embodiment, the first direction load cell 201, the second direction load cell 202, the third direction load cell 203, the fourth direction load cell are respectively control the four moving directions by the user's feet. When the user moves the center of gravity to the first direction load cell 201, the pressure on the pressure-sensing plane of the first direction load cell 201 increases, such that the amplitude of the first electrical signal ES1 is higher than those of the second electrical signal ES2, the third electrical signal ES3 and the fourth electrical signal ES4. Meanwhile, the control circuit 206 controls the motion mechanism 205-1 to move towards the first direction.

Similarly, when the user moves the center of gravity to the middle of the first direction load cell 201 and the second direction load cell 202, the pressure on the pressure-sensing planes of the first direction load cell 201 and the second direction load cell 202 respectively increase, such that the amplitudes of the first electrical signal ES1 and the second electrical signal ES2 are higher than those of the third electrical signal ES3 and the fourth electrical signal ES4. At this time, the control circuit 206 controls the motion mechanism 205-1 to move towards the direction between the first direction and the second direction.

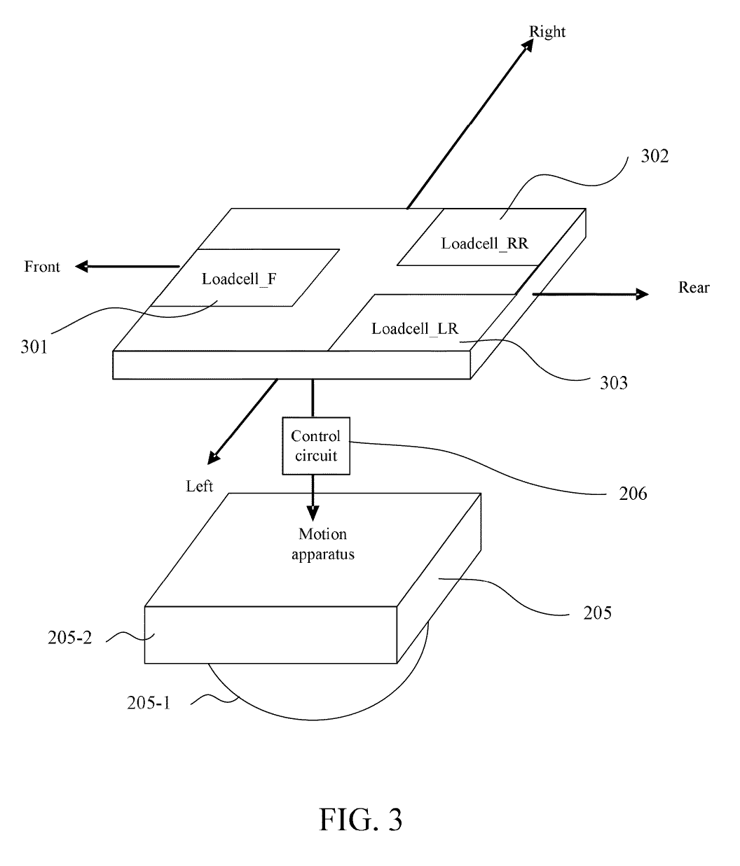

According to the abovementioned embodiment, the self-balance mobile carrier adopts human balance function. The pressure distribution during the user keeping balance is detected by the four load cells to determine the balance direction, and then the detection of four load cells is used for controlling the moving direction of the motion apparatus. In this present embodiment, four load cells adopt for determining the moving directions. However, people having ordinary skill in the art should know that three load cells are quite enough to determine user's center of gravity in two axes of an plane and to control the moving directions, as shown in FIG. 3. FIG. 3 illustrates a diagram depicting a self-balance mobile carrier according to a preferred embodiment of the present invention. In this embodiment, there are only three load cells 301, 302 and 303.

In addition, in the abovementioned embodiment, the motion mechanism 205-1 of the motion apparatus 205 may be a universal ball or a universal caster. Thus, people having ordinary skill in the art should know that the motion mechanism could be adopted in the present invention as long as the direction thereof is controllable and the it can carrier a user. Thus, the present invention is not limited thereto.

According to the abovementioned embodiment, the self-balance mobile carrier of the preferred embodiment of the present invention can be used to a snakeboard, a skateboard, a kick scooter, and so on. The present invention let user control the self-balance mobile carrier intuitionally. Thus, if any mobile carrier detects the offset of the center of gravity to control the moving direction by the detection result, the said mobile carrier belongs to the application of the present invention.

In summary, the spirit of the present invention is to use human balance function and multiple load cells to detect foot pressure distribution to determine the user's balance direction, and then the load cells control the corresponding moving directions of the motion apparatus. Thus, the complexity of the system is reduced. In addition, the mobile carrier can operate without the gyroscope, g-sensor or accelerometer. The present invention predigests the control mechanism. In the aspect of directional calculation, the present invention is no need complex calculation for acquiring an offset of the center of gravity. Thus, the cost will be reduced, and the user can control the self-balance mobile carrier more instinctively.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A self-balance mobile carrier, comprising:
a first direction load cell, comprising a pressure-sensing plane and an electrical signal output terminal, wherein the first direction load cell is used for converting a pressure of the pressure-sensing plane thereof into a first electrical signal and outputs the first electrical signal to the electrical signal output terminal thereof;
a second direction load cell, comprising a pressure-sensing plane and an electrical signal output terminal, wherein the second direction load cell is used for converting a pressure of the pressure-sensing plane thereof into a second electrical signal and outputs the second electrical signal to the electrical signal output terminal thereof;
a third direction load cell, comprising a pressure-sensing plane and an electrical signal output terminal, wherein the third direction load cell is used for converting a pressure of the pressure-sensing plane thereof into a third electrical signal and outputs the third electrical signal to the electrical signal output terminal thereof;
a motion apparatus, comprising a motion mechanism and a carrier plane, wherein the carrier plane thereof is used for carrying the first direction load cell, the second direction load cell, and the third direction load cell; and
a control circuit, coupled to the electrical signal output terminals of the first direction load cell, the second direction load cell, and the third direction load cell and the motion apparatus,
wherein the control circuit changes the moving direction of the motion apparatus according to the difference of the first electrical signal, the second electrical signal and the third electrical signal.

2. The self-balance mobile carrier according to claim 1, further comprising:
a fourth direction load cell, comprising a pressure-sensing plane and an electrical signal output terminal, wherein the fourth direction load cell is used for converting a pressure of the pressure-sensing plane thereof into a fourth electrical signal and outputs the fourth electrical signal to the electrical signal output terminal thereof;
wherein the control circuit is further coupled to the electrical signal output terminal of the fourth direction load cell,
wherein the carrier plane is used for carrying the fourth direction load cell,
wherein the control circuit changes the moving direction of the motion apparatus according to the difference of the first electrical signal, the second electrical signal, the third electrical signal and the fourth electrical signal.

3. The self-balance mobile carrier according to claim 1, wherein the motion apparatus is an universal ball.

4. The self-balance mobile carrier according to claim 1, wherein the motion apparatus is an universal caster.
